(19) United States
(12) Patent Application Publication
(10) Pub. No.: US 2013/0098752 A1
(43) Pub. Date: Apr. 25, 2013

(54) Process and Apparatus for the Distillation of Polymerization-Prone Compounds

(71) Applicants: Frank Castillo-Welter, Friedrichsdorf (DE); Klaus Kirsten, Mainz (DE); Jochen Bauer, Frankfurt am Main (DE); Christoph Steden, Oberursel (DE); Dominic Walter, Darmstadt (DE); Markus Kreich, Otzberg (DE); Rudolpf Zeyen, Frankfurt am Main (DE)

(72) Inventors: Frank Castillo-Welter, Friedrichsdorf (DE); Klaus Kirsten, Mainz (DE); Jochen Bauer, Frankfurt am Main (DE); Christoph Steden, Oberursel (DE); Dominic Walter, Darmstadt (DE); Markus Kreich, Otzberg (DE); Rudolpf Zeyen, Frankfurt am Main (DE)

(73) Assignee: LURGI GMBH, Frankfurt am Main (DE)

(21) Appl. No.: 13/583,278

(22) PCT Filed: Jan. 28, 2011
(86) PCT No.: PCT/EP11/00384

§ 371 Date: Nov. 8, 2012

(30) Foreign Application Priority Data
Mar. 10, 2010 (DE) 10 2010 010 997.5

(51) Int. Cl. B01D 3/00

(52) U.S. Cl. CPC B01D 3/00
USPC 203/8; 202/176

(57) ABSTRACT

In a process for distilling polymerization-prone compounds from liquid mixtures of matter which, apart from the readily polymerizable compound, also contain other components and also polymerization inhibitors, the evaporator is operated in forced circulation and at a pressure which makes possible superheating of the liquid with respect to its boiling point at the pressure within the distillation column. This is achieved by transporting the superheated liquid against a flow restrictor, e.g. an orifice plate. The liquid which is expanded and partially evaporated on passage through the flow restrictor is returned to the distillation column. In this manner the formation of an open vapour space in the evaporator circuit after heating downstream of the heat exchanger is avoided in that, in the design of the evaporator of the prior art, formation of polymer deposits frequently occurs.

### FIELD OF THE INVENTION

This invention relates to a process for the distillative treatment of substance mixtures which contain polymerization-prone compounds. In particular, the invention relates to the distillative purification of acrylic acid or methacrylic acid. This invention furthermore relates to an apparatus for carrying out the process according to the invention.

### PRIOR ART

Acrylic acid and its esters are increasingly used around the world and chiefly are used in the production of polymers. As is explained in Ullmann's Encyclopedia of Industrial Chemistry, Sixth Edition, 1998 Electronic Release, keyword “Acrylic Acid and Esters”, the major part of the commercially utilized acrylic acid is produced by selective oxidation of propene, which also represents the starting material for acrolein. The selective oxidation of propene is carried out as heterogeneously catalyzed reaction in the gas phase by using air as oxidant. From the gaseous product mixture obtained thereby, the acrylic acid generally is first separated by absorption by means of an absorbent, in most of the processes water or an aqueous solution. For this purpose, however, organic solvents also are employed. By extraction with a further solvent, the acrylic acid often is subsequently transferred into the same and finally obtained in the required purity by distillation. In some processes, the azeotropic distillation initially is employed instead of the extraction step.

For extracting acrylic acid from the mostly aqueous solution, various solvents can be utilized. The first group of solvents comprises those substances which have smaller boiling points than acrylic acid, for example ethyl acetate, butyl acetate, ethyl acrylate and 2-butanone as well as mixtures thereof. The second group includes solvents with higher boiling points than acrylic acid, such as for example tert-butyl phosphate, isophorone and aromatic hydrocarbons. Mixtures of these low- and high-boiling solvents form a third group.

Evaporating the liquid phase containing the acrylic acid during the distillation usually is carried out in distillation apparatuses with external circulation evaporator with natural circulation, wherein the liquid usually is heated by indirect heat exchange against a heating medium in a tube bundle heat exchanger. Since acrylic acid polymerizes easily, the distillation columns are operated by adding polymerization inhibitors such as hydroquinone or hydroquinone monomethylether. Furthermore, the column pressure is lowered during the distillation, in order to decrease the boiling point and hence the thermal load of the distillation feedstock. Nevertheless, the risk of an undesired polymerization exists in particular during evaporation, since the acrylic acid (normal boiling point 142° C.) or the methacrylic acid (normal boiling point 163° C.) are separated from the polymerization inhibitors such as hydroquinone (normal boiling point 285° C.) or hydroquinone monomethylether (normal boiling point 243° C.) (all boiling point data from NIST Chemistry WebBook, http://webbook.nist.gov/chemnistry/, converted into ° C.). Therefore, these inhibitors remain in the liquid, and when the pure acrylic acid vapors condense again, for example on apparatuses and conduits, the polymerization starts, and there are formed deposits in the form of polymer particles or poorly soluble layers of polymerisate.

In particular the upper region of the heat exchanger of the circulation evaporator is not permanently flown around by liquid which contains the inhibitor, since the vapor phase takes up most of the free volume in the evaporator. As a result, local overheating and thus an increased thermal load of the medium to be heated and also a thermal damage of the inhibitor left can occur on the product-side surface of the heat exchanger, which leads to inhibitor losses and promotes the soiling of the heat exchanger. Over an extended operating time, undesired deposits thus form on the heat exchanger, which in operation are not completely removed again, but are accumulated further and deteriorate the product quality and reduce the thermal effectiveness of the heat exchanger. Furthermore, the risk of the formation of deposits in the evaporator must be valued higher as compared to the distillation column, since due to the smaller conduit cross-sections and the higher temperatures the risk of clogging here is considerably higher.

These disadvantages require the repeated chemical or mechanical cleaning of the heat exchangers concerned and the conduits concerned, which can only be effected during shutdown of the plant. The plant availability and hence the production capacity is decreased thereby. To eliminate these problems, various solutions have been proposed already in the prior art.

The European Patent Specification EP 1029572 B1 for example teaches a process for the distillation of a polymerizable compound or of a liquid containing such compound in a distillation column which is equipped with a vertically arranged tube bundle heat exchanger as evaporator, which is operated in natural circulation. It is proposed to arrange the return conduit from the reboiler into the distillation column such that the recirculation of the vapor is effected into the vapor space of the column, wherein the exact position of the introduction of the return conduit into the column has a mathematical relationship to the upper edge of the heat exchanger tube bundle, and wherein the inside diameter of the return conduit has a mathematical relationship to the inside diameter of the evaporator housing. The objective of this measure is to achieve an acceleration of the vapor before entry into the distillation column, in order to avoid deposits above the tube bundle and at the point of entry into the column. Furthermore, the height of the liquid level in the distillation column should be adjusted such that the same lies below the lower edge of the return conduit entering into the column, but above the liquid level covering the tube bundle, with mathematical relationships also being indicated for this. By means of this measure, the boiling point of the liquid containing the polymerizable compounds should be raised and thus the polymerization within the heat exchanger tube bundle should be suppressed. On the whole it should be noted that the polymerization in the free volume of the evaporator above the tube bundle probably is reduced by said measures, but not principally avoided.

In the European Patent Specification EP 1043050 B1 it is proposed to design a process for the distillation of a liquid containing a polymerizable compound in a distillation column such that in the feed conduits between evaporator and distillation column or between distillation column and evaporator certain linear velocities of the vapor should be maintained and the polymerization-prone compound condenses as quickly as possible and is withdrawn from the column. In a particular aspect of the invention it is proposed to integrate the evaporator and/or the condenser into the distillation column, in order to minimize the free gas space within the column and hence minimize the mean residence time of the vapor. When applying this teaching, problems should occur however, in particular during start-up and shut-down operations, since then the required linear vapor velocities can not yet or no longer be maintained. The integration of evaporator and condenser furthermore lowers the work volume usable for rectification and hence the production capacity of the distillation column.

In general, it can therefore be noted that a really satisfactory technical solution for the design and operation of an evaporator in the distillation of polymerization-prone compounds, such as acrylic acid, has not been found so far, which solution is characterized by operational safety and high plant availability and principally avoids the formation of deposits in the evaporator as far as possible. This equally relates to the processing and purification of other polymerization-prone compounds, such as for example methacrylic acid.

### DESCRIPTION OF THE INVENTION

Therefore, it is the object of the present invention to provide a process for the distillation of substance mixtures with polymerization-prone ingredients and a corresponding apparatus, which avoid the described disadvantages. In particular, the formation of disturbing deposits in the free volume of the evaporator, the outlet hood and the outlet conduit should principally be inhibited with the invention as far as possible.

The aforementioned object is solved with the invention substantially by the features of claim 1.

It has been found that the operation of the evaporator in forced circulation leads to the solution of the object, when it is operated in a way in which the formation of a free gas-vapor space is avoided in the entire conduit path outside the distillation column, and the evaporation is effected abruptly on re-entry of the heated liquid into the distillation apparatus, e.g. the distillation column. This finding is surprising in so far as the prior art, e.g. the patent specification EP 1029572 B1 discussed above, advises against a forced-circulation operation of an evaporator during the distillation of liquids containing easily polymerizable compounds. The advantageous operation of the evaporator in forced circulation becomes possible in that the pressure on the liquid bottom product withdrawn from the distillation apparatus, which is recirculated to the distillation apparatus, is increased by superheating and delivering against a flow restriction means, preferably aorifice orifice, a valve, a throttle, a perforated disk, a nozzle, a capillary or combinations thereof. As a result, the liquid is superheated above its boiling point with respect to the pressure in the interior of the distillation apparatus.

When the superheated liquid passes through the flow restriction means and again enters into the distillation apparatus, an abrupt evaporation of the liquid is effected. This abrupt evaporation, which proceeds with a considerable increase in volume, leads to an acceleration of the fluid stream entering into the distillation apparatus, whereby the risk of a formation of deposits for example of polymers at the point of entry into the distillation apparatus is reduced. It therefore is advantageous when the flow restriction means is arranged directly upstream of the re-entry of the superheated liquid into the distillation apparatus, or even in its interior. Preferably, the distillation apparatus is operated in a manner known per se by adding polymerization inhibitors at suitable points, for example in the vicinity of the point of re-entry of the superheated liquid into the distillation column. In this way, it is avoided that vapors of the easily polymerizable compound occur in containers and conduits which are not wetted with inhibitor solutions.

In principle, the invention can be employed in the continuous distillation in a distillation column, but also in the intermittently performed distillation, e.g. in a distillation still. Bottom product not necessarily is understood to be a liquid product withdrawn at the deepest and/or hottest point of the distillation apparatus, but generally a liquid product withdrawn in the lower part of the distillation apparatus. Likewise, top product in a non-limiting manner is understood to be a product withdrawn at the highest and/or coldest point of the distillation apparatus, but generally a gaseous or liquid product withdrawn in the upper part of the distillation apparatus.

Advantageously, by operating the evaporator in a forced circulation, a higher flow velocity of the liquid as compared to the operation with natural circulation is achieved in the heating device, e.g. in the tube bundle of the heat exchanger. A continuous cleaning of the heat-exchange surfaces by the flowing product is achieved thereby. Another advantage of the invention is the improved heat transfer between heat exchanger and heated liquid due to the increased flow velocity, which in turn contributes to avoiding local superheating.

The driving force for the delivery of the liquid in operation of the evaporator with natural circulation is the thermosiphon effect, i.e. changes in density of the liquid due to its heating and evaporation. The low power resulting therefrom for the delivery of the liquid makes it necessary to design the conduits and the evaporator in so large dimensions that the equipment includes an undesirably large product quantity, which results in an undesirably long residence time of the product under thermal load. The flow velocity of the liquid flowing through the heating device is dependent on the pressure loss of the circulation system and on the achieved temperature increase and evaporation rate. In evaporator operation with natural circulation, the flow velocity of the liquid usually is low and amounts to about 0.2 to 1.5 m/s. This flow velocity of the circulating liquid often is not sufficient to provide for a sufficient cleaning of the surfaces in contact with the media. Impurities which get into the circulation or are produced there cover the heat-exchange surfaces and durably and increasingly deteriorate the efficiency of the heating device.

Another advantage of the invention also is the possibility of specifically reducing the size of the heating device, e.g. the heat exchanger, and the associated conduits, when operating the evaporator with forced circulation. As a result, the product quantity in the heating device and hence the residence time of the thermally sensitive product is reduced under an increased temperature load. As a direct consequence, the undesired side reaction of the acrylic acid to its dimer is reduced. This advantage must be valued higher than the slight additional thermal load of the easily polymerizable compound and the polymerization inhibitor caused by the operation of the heat exchanger at increased pressure and increased temperature.

### PREFERRED ASPECTS OF THE INVENTION

When carrying out the process according to the invention, a pump particularly preferably is used as conveying device, in order to provide for the operation of the evaporator in forced circulation. The pump preferably is arranged between the withdrawal conduit and the heating device, so that the pressure on the heating device succeeding in flow direction is increased, in order to prevent an evaporation of the liquid downstream after the same. A further pump can be used for discharging the liquid bottom product stream.

In accordance with a development of the invention, a means for separating solid impurities, preferably a filter, can be provided upstream and/or downstream of the conveying device. The means for separating solid impurities preferably is provided upstream of the conveying device, in order to protect the same against contamination, clogging or damage. In this way, undissolved solid impurities such as polymerisate particles can largely be removed, before they get into the heating device and there can lead to cloggings. It is expedient to provide the filter with a connectable bypass conduit, in order to be able to remove the same for cleaning or for replacement without interruption of the process.

A preferred aspect of the process according to the invention provides to use a tube bundle heat exchanger as heating device, which operates by indirect heat exchange against a heating medium. The same preferably is operated in a horizontal installation, but with the invention other ways of installation also become possible. However, heating of the liquid withdrawn from the distillation apparatus also is possible with electric energy.

According to a preferred aspect of the invention aorifice orifice, a valve, a throttle, a perforated disk, a nozzle, a capillary or combinations thereof are used as flow restriction means. Particularly preferably, the opening characteristic of the flow restriction means is adjustable. Even at changed flow velocities, as they can occur for example during start-up and shut-down operations, the pressure in the evaporator thus can always safely be maintained above the boiling pressure of the liquid, based on the pressure in the interior of the distillation apparatus.

The use of plate heat exchangers or spiral heat exchangers instead of tube bundle heat exchangers is a further configuration possibility of the invention, since here the same advantages as in the tube bundle heat exchanger can be achieved when maintaining corresponding velocities and with a suppressed evaporation.

The process according to the invention is suitable for the distillative separation of liquid substance mixtures which contain easily polymerizable compounds. Particularly preferably, the process according to the invention is applied for obtaining acrylic acid or methacrylic acid from liquid mixtures with lower boiling solvent. The acrylic acid or methacrylic acid is withdrawn as high boiling bottom product. The lower boiling solvent is obtained as top product and after condensation for example can be reused as extracting agent. It is advantageous that the usually employed polymerization inhibitors remain in the bottom product due to their even higher boiling point and protect the acrylic acid or methacrylic acid contained therein against undesired oligomerization or polymerization.

In principle, the process according to the invention also is usable for separating and obtaining easily polymerizable compounds from higher boiling solvents. The easily polymerizable compounds are obtained as top product of the distillation. A particularly efficient and uniform addition of inhibitor should be ensured in the entire distillation apparatus.

The spatial installation site of the heating device now can be disposed at almost any distance from the connected distillation apparatus, and the mounting position of the heating device in principle can be chosen as desired. This increases the configuration possibilities when installing the apparatuses in a new plant.

The invention also relates to an apparatus for carrying out the process according to the invention. It is characterized by
a distillation apparatus for the distillative separation of liquid substance mixtures which contain easily polymerizable compounds,
a conduit for withdrawing the liquid bottom product from the lower part of the distillation apparatus as product stream,
a conduit for withdrawing the liquid bottom product from the lower part of the distillation apparatus as return stream,
a conduit for recirculating the return stream,
a pump as driving force for the forced circulation,
a heating device, e.g. a heat exchanger, for superheating the liquid,
a flow restriction means for adjusting a pressure difference between the interior of the distillation apparatus and the return conduit after exit from the heating device,
a return conduit for recirculating the superheated return stream from the heating device to the distillation apparatus,
a conduit for withdrawing the top product.

In the apparatus according to the invention, aorifice orifice, a valve, a throttle, a perforated disk, a nozzle, a capillary or combinations thereof preferably are used as flow restriction means.

Further developments, advantages and possible applications of the invention can also be taken from the following description of exemplary embodiments and the drawing. All features described and/or illustrated form the invention per se or in any combination, independent of their inclusion in the claims or their back-reference.

In the drawing:

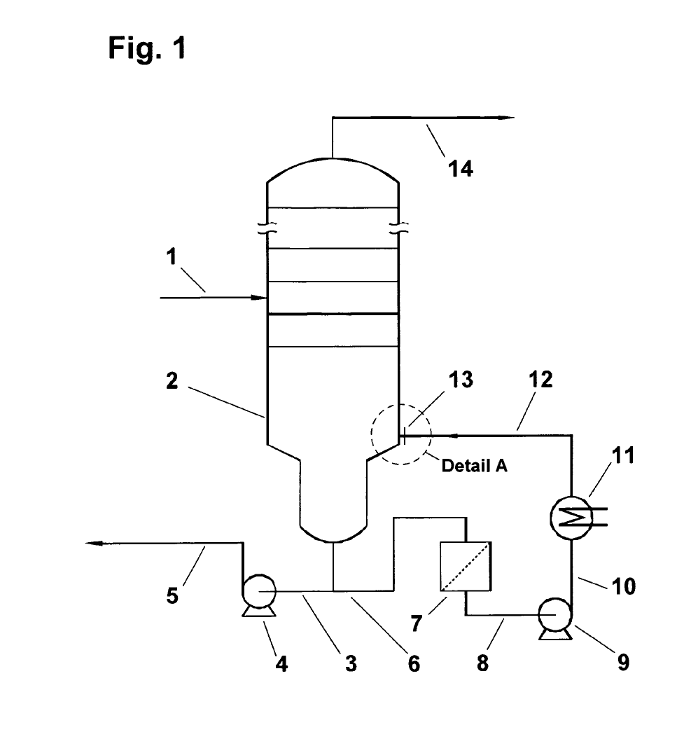

FIG. 1 schematically shows a plant for carrying out the process of the invention,

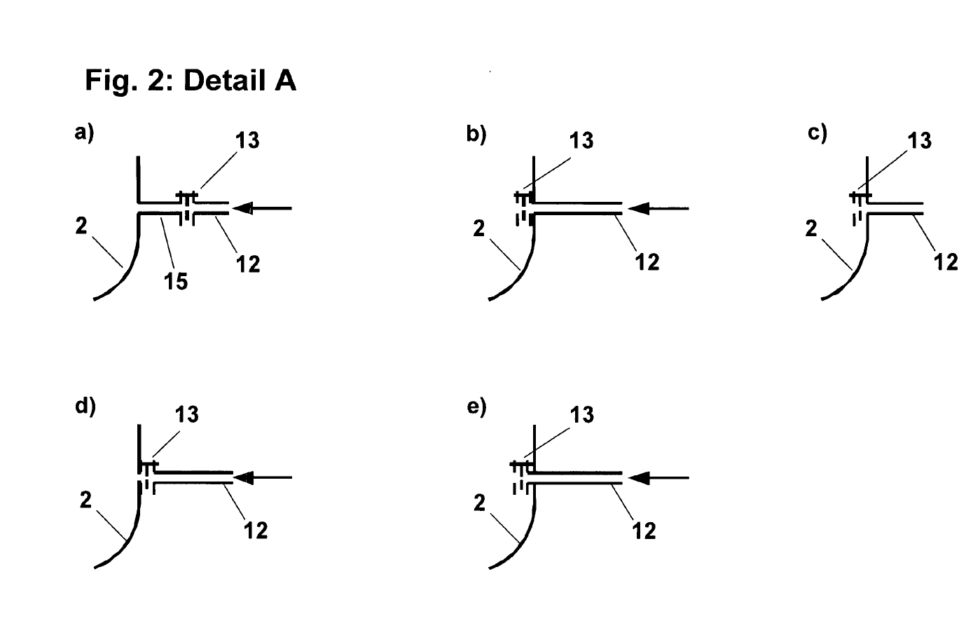

FIG. 2 shows various configurations of the flow restriction means.

FIG. 1 schematically shows a plant for carrying out the process according to the invention, wherein acrylic acid as easily polymerizable, high boiling compound is separated from the low boiling solvents cyclohexane (normal boiling point 81° C.) and isopropyl acetate (normal boiling point 89° C.). The liquid to be separated, which contains acrylic acid, the solvents and hydroquinone as polymerization inhibitor, is charged as first liquid stream via conduit 1 to the distillation apparatus 2, here a distillation column. In the distillation column, the separation of the liquid is effected according to the boiling points of the substances contained therein. In the distillation column, tray types insensitive to soiling preferably are provided as separating devices, but a configuration with structured packings also is possible. At several points within the distillation column, metering points for the polymerization inhibitor are provided (not shown in FIG. 1). The withdrawal of the high boiling liquid bottom product of the distillation, which substantially contains acrylic acid, is effected via conduits 3 and 5 and the pump 4 in a manner known per se. A partial stream of the bottom product withdrawn is withdrawn via conduits 6, 8 by means of a pump 9 and recirculated to the distillation column. This partial stream likewise contains the acrylic acid, the solvents and the polymerization inhibitor. For separating polymerisate particles and other solid impurities, the return stream preferably is guided over a filter 7. The same is provided with a bypass conduit not shown in FIG. 1, in order to provide for a cleaning or a replacement of the filter. Alternatively, the filter 7 also can be arranged before the division of the bottom product withdrawn from the column into conduits 3 and 6. For applications in which few or no solid impurities are obtained, the filter 7 can also be omitted.

Via conduit 10, the recirculated liquid stream subsequently is supplied to a tube bundle heat exchanger 11. The tube bundle heat exchanger is operated in horizontal position and by indirect heat exchange against low-pressure steam as heating medium. In the tube bundle heat exchanger the recirculated liquid stream is superheated due to the excess pressure generated between the pump 9 and the flow restriction means 13 with respect to its boiling point at the pressure within the distillation column. It therefore leaves the tube bundle heat exchanger as superheated, liquid return stream and is delivered against the flow restriction means 13. In the present example, this is a orifice orifice with fixed opening characteristic; the adjustment of the excess pressure with respect to the internal column pressure is effected by calculating a corresponding opening cross-section relative to the previously determined delivery rate of the pump. The minimum delivery rate of the pump chiefly depends on the maximum admissible temperature increase of the liquid to be heated and the heat exchanger geometry with regard to the velocity criteria to be observed.

It is also possible to use a flow restriction means, e.g. a valve, with adjustable opening characteristic. At low load, for example, the adjustment of the delivery rate of the pump 9 thereby can be adapted to the desired or necessary excess pressure.

When the superheated, recirculated liquid stream passes through theorifice orifice, an abrupt partial evaporation takes place, with the lower boiling components preferably passing over into the vapor phase. After condensation, the lower boiling components are obtained as liquid at the top of the distillation column in a manner known per se, withdrawn via conduit 14 and recirculated to the acrylic acid extraction not shown in FIG. 1. Alternatively, the solvents also can be withdrawn from the distillation column in the form of vapor and be recirculated to the acrylic acid extraction, wherein the condensation must be effected before a renewed use as extracting agent.

FIG. 2 schematically shows particular configurations and arrangement possibilities of the flow restriction means 13, here the orifice (detail A in FIG. 1). In FIG. 2 a) the orifice 13 is arranged outside the distillation column 2. Via conduit 12, the superheated, recirculated liquid stream is guided against the orifice 13 in direction of arrow. The liquid stream partly evaporated after expansion is recirculated to the distillation column via conduit 15. It is recommended to design the conduit 15 as short as possible in this configuration and/or to install the same with a downward slope, in order to ensure a free back flow of the partly evaporated liquid into the distillation column 2.

In the embodiments shown in FIG. 2 b) and c), the flow restriction means 13 is arranged within the distillation column 2. In FIG. 2 b) the orifice is enclosed by two holders and is connected with the inner wall of the distillation column 2 as assembly. In the configuration shown in FIG. 2 c), the inner wall of the distillation column 2 serves as holder, so that only the side of the orifice facing the column interior must be provided with an additional holder. What is disadvantageous in the configurations shown in FIG. 2 b) and c) is the poor accessibility of the flow restriction means during revisions.

The embodiment shown in FIG. 2 d) is similar to that shown in FIG. 2 a). The return conduit 15, however, is omitted here, because the assembly consisting of orifice and holders is applied directly onto the outer wall of the distillation column 2. For example, a so-called block flange can be used, which is integrated into the container wall.

The embodiment shown in FIG. 2 e) is similar to that shown in FIG. 2 b) and c). The orifice in turn is arranged in the interior of the distillation column 2, but not connected with its inner wall, and instead mounted at the end of the conduit 12 protruding into the distillation column.

### NUMERICAL EXAMPLES

The following numerical examples relate to the separation of acrylic acid from lower boiling solvents, but also to the recovery of pure acrylic acid as distillation top product. As pump, a centrifugal pump is used with a delivery rate of 5 to 50 times the amount of liquid withdrawn from the distillation column, which flows to the evaporator, and generates a pressure increase of at least 10 kPa between heat exchanger and flow restriction means. Heating the liquid in the evaporator is effected by means of a tube bundle heat exchanger.

The flow restriction means is configured as perforated disk. The pressure between heat exchanger and flow restriction means is chosen via the hole diameter and the delivery rate of the pump such that the temperature of the superheated liquid before the perforated disk lies about 5° C. below the boiling temperature at this pressure. Thus, it is ensured that an evaporation will only start after the expansion behind the perforated plate. Depending on the working pressure in the bottom of the column (usually between 8 and 50 kPa(a)), an excess pressure of 10 to 100 kPa is preferred, based on the preferred circulation rates of 10 to 15, wherein the circulation rate is defined as quantity ratio of liquid pumped over to evaporated liquid.

The product temperature at the outlet of the heat exchanger is chosen such that it lies 5 to 15° C. above the bottom temperature. To achieve the self-cleaning effect of the conduits in the tube bundle heat exchanger, the flow velocity in the tube bundle is designed for a value>1.5 m/s.

In the following tables, mass flows, temperatures and pressures are listed for distillative separations by the process according to the invention, which occur in the production of acrylic acid from propene by selective oxidation.

### Example 1

Separation of lower boiling components (solvent/water) as top product. The bottom product chiefly consists of acrylic acid.

| | Conduit 1 | | | |
|---|---|---|---|---|
| | Column | Conduit 3 | Conduit 12 | Conditions |
| | feed | Bottom product | Recirculation | Column bottom |
| Mass flow | 100 | 30.7 | 1285 | — |
| [kg/h] | | | | |
| Temperature | 49 | 94 | 109 | 94 |
| [° C.] | | | | |
| Pressure | two-phase | liquid (>51) | >90 | 51 |
| [kPa(a)] | | | | |

### Example 2

Separation of pure acrylic acid as top product. Beside acrylic acid, the bottom product also contains oligomers as impurity and inhibitor.

| | Conduit 1 | | | |
|---|---|---|---|---|
| | Column | Conduit 3 | Conduit 12 | Conditions |
| | feed | Bottom product | Recirculation | Column bottom |
| Mass flow | 100 | 11.1 | 3030 | — |
| [kg/h] | | | | |
| Temperature | 20-96 | 90 | 102 | 90 |
| [° C.] | | | | |
| Pressure | liquid | liquid (>8) | >17 | 8 |
| [kPa(a)] | | | | |

### INDUSTRIAL APPLICABILITY

With the invention an improved process is proposed for obtaining easily polymerizable compounds, in particular acrylic acid or methacrylic acid, in the distillative separation of a solvent, e.g. an extracting agent, which is characterized by low susceptibility to failure, maintenance friendliness, operational safety and long operating intervals. By avoiding deposits on the heat-exchange surfaces, the operating period of the heat exchanger is prolonged. The loss of inhibitor by thermal decomposition is reduced. An undesired oligomerization or polymerization of the easily polymerizable compound in the free vapor space of conventional evaporators and the connected conduits principally is inhibited.

### LIST OF REFERENCE NUMERALS

1 conduit

2 distillation column

3 conduit

4 pump

5 conduit

6 conduit

7 filter

8 conduit

9 pump

10 conduit

11 heat exchanger

12 conduit

13 orifice

14 conduit

15 conduit

1. A process for obtaining an easily polymerizable compound from a liquid substance mixture, said mixture comprising the easily polymerizable compound, at least one second substance and at least one polymerization inhibitor, by distillation in a distillation apparatus, wherein the distillation apparatus is equipped with at least one heating device, and wherein the second substance has a different boiling point than the easily polymerizable compound, wherein the process comprises:
(a) supplying the liquid substance mixture to the distillation apparatus and distillative separation into a top product and a bottom product,
(b) withdrawing a part of the liquid bottom product in the lower part of the distillation apparatus and discharging the same as product stream,
(c) withdrawing a further part of the liquid bottom product in the lower part of the distillation apparatus as return stream,
(d) supplying the return stream to a heating device and discharging a superheated, liquid return stream, wherein the superheated return stream is heated above its boiling point with respect to the pressure in the interior of the distillation apparatus,
(e) delivering the superheated return stream against a flow restriction means and discharging a partly evaporated fluid stream,
(f) recirculating the partly evaporated fluid stream into the distillation apparatus, and
(g) withdrawing a top product stream in the upper part of the distillation apparatus.

2. The process according to claim 1, wherein the easily polymerizable compound is obtained in the bottom product, when its boiling point is higher than the boiling point of the second substance.

3. The process according to claim 1, wherein the easily polymerizable compound is obtained in the top product, when its boiling point is lower than the boiling point of the second substance.

4. The process according to claim 1 wherein the liquid bottom product is treated with a means for separating solid impurities.

5. The process according to claim 1 wherein a tube bundle heat exchanger is used as a heating device, and said tube bundle, operates by indirect heat exchange against a heating medium.

6. The process according to claim 1 wherein an orifice, a valve, a throttle, a perforated disk, a nozzle, a capillary or combinations thereof are used as flow restriction means.

7. The process according to claim 1 wherein the flow restriction means has an adjustable opening.

8. The process according to claim 1 wherein acrylic acid or methacrylic acid is obtained from mixtures with lower boiling or higher boiling solvents.

9. An apparatus for carrying out a process according to claim 1 comprising a distillation apparatus, a conduit for withdrawing the liquid bottom product as product stream, a conduit for withdrawing the liquid bottom product as return stream, a conduit for recirculating the return stream, at least one pump, a heating device, a flow restriction means, a return conduit for recirculating the superheated return stream to the distillation apparatus and a conduit for withdrawing the top product.

10. The apparatus according to claim 9, wherein an orifice, a valve, a throttle, a perforated disk, a nozzle, a capillary or combinations thereof are used as flow restriction means.
